(19) United States
(12) Patent Application Publication
(10) Pub. No.: US 2026/0319440 A1
(43) Pub. Date: Oct. 15, 2026

(54) REMOVABLE WRISTBAND

(71) Applicant: The Swatch Group Research and Development Ltd, Marin-Epagnier (CH)

(72) Inventor: Philipp TSCHUMI, Niederwil (CH)

(73) Assignee: The Swatch Group Research and Development Ltd, Marin-Epagnier (CH)

(21) Appl. No.: 19/573,077

(22) Filed: Mar. 20, 2026

(30) Foreign Application Priority Data
Apr. 11, 2025 (EP) 25170116.5

(51) Int. Cl. G04B 37/14

(52) U.S. Cl. CPC G04B 37/1493

(57) ABSTRACT

A removable wristband (1) that can be connected to a watch case (201), the wristband including a fastening element (10), at least two retractable pins (4, 4') held in an extended position by elastic return means (5), two movable levers (3, 3') independent of each other, the movement of said levers (3, 3') moving the pins (4, 4') into a retracted position allowing the wristband to be detached from the frame, the movement of the levers (3, 3') being caused by simultaneously exerted pressure on push rods (20, 20') in a transverse direction relative to the wristband, leading to elastic deformation of the push rods (20, 20') and unlocking the wristband from the frame to allow the wearer to detach the wristband from the frame , the push rods (20, 20') being integral with the wristband (1), with a push rod (20, 20') formed on each edge of the wristband.

### CROSS REFERENCE TO RELATED APPLICATION

This application claims priority to European Patent Application No. 25170116.5 filed Apr. 11, 2025, the entire contents of which are incorporated herein by reference.

### TECHNICAL FIELD OF THE INVENTION

The present invention relates to the field of watchmaking or jewellery. It relates more specifically to a wristband with a device for attaching to an object, in particular to a watch case.

### TECHNOLOGICAL BACKGROUND

Generally, the wristbands, either made of leather or metal, are attached to the lugs of a watch case, by means of a bar formed from a tube, in which two pistons that move in translation are mounted, and an elastic element arranged between said pistons and tending to push them towards the outside of the tube. The said bar is mounted in a housing provided for this purpose at one end of the wristband, and the pistons are engaged in blind or through bores made opposite each other in the lugs of the case.

To detach a wristband thus attached to a case, a tool designed to push the pistons back into the tube, against the stress exerted by the elastic element, is required to extract them from the bores. The wearer of the watch does not have such a tool at all times, and in addition, it may be inconvenient to use. For this reason, wristbands with such a fastening device are generally permanently attached to the case.

In addition, there are fastening devices that allow the wristband to be detached from the case without the need for a tool. For example, we know from document CH 694 393 of a device for attaching the end of a wristband to the case of a watch according to the invention is of the type comprising, on the one hand, two aligned tenons transversely to said end, at least one of which is movable in axial movement in a channel from which it can partially be extracted in order to allow attachment to the lugs of said case by engaging said extracted part in one of the aligned holes that each of said lugs includes; and on the other hand a movable element that is elastically returned, capable of allowing the said tenon or tenons to be moved, and is characterised essentially in that the one or more said tenons are freely movable and are bound to the said movable element by means allowing, through the translation of said movable element in a direction different from that of the movement of the said tenon or tenons, the latter to be driven in axial translation.

However, such a solution presents the disadvantage of potentially jamming when pushing the push rod due to the competing axes along which the two sections of pins must respectively slide.

In this context, it is understood that there is a need to find a solution, in particular that does not present the disadvantages of the prior art.

### SUMMARY OF THE INVENTION

The invention aims in particular to remedy the various disadvantages of the prior art.

More specifically, one objective of the invention is to provide a removable wristband of simple, discreet and reliable construction.

To this end, the invention relates to a removable wristband that can be connected to the frame of a watch case, the wristband comprising a fastening element, at least two retractable pins held in an extended position by elastic return means, two movable levers independent of each other, the movement of said levers moving the pins into a retracted position allowing the wristband to be dislodged from the frame, the movement of the levers being caused by simultaneously pushing the push rods in a transverse direction relative to the wristband leading to elastic deformation of the push rods and unlocking the wristband from the frame to allow the wearer to detach the wristband from the frame, the push rods being integral with the wristband, one push rod being arranged on each edge of the wristband.

According to other advantageous variants of the invention:

The fastening element has a housing in which the levers, pins and elastic return means are housed;

The fastening element comprises two through holes arranged to receive the pins, each pin being protruding;

The fastening element is sealed by a cover;

The levers are rotationally hinged around a pin in the housing;

Each lever comprises a finger arranged to cooperate with a pin;

Each lever comprises a protrusion arranged to rest in a cavity of a push rod;

The fastening element comprises openings for the passage of the projections of the levers toward the cavities;

The wristband comprises complementary means of attaching with the fastening element;

The cover comprises a passageway for guiding and maintaining the pins and the elastic return means in translation;

The cover includes two holes arranged to cooperate with the pins so as to axially hold the levers;

The wristband is made of a material such as rubber or silicone;

The fastening element is made of a rigid synthetic material such as polyoxymethylene.

The invention also relates to a watch equipped with a wristband in accordance with the invention.

### BRIEF DESCRIPTION OF THE FIGURES

Other features and advantages of the invention will become apparent from the following detailed description, given by way of non-limiting example, with reference to the attached drawings in which:

FIG. 1 represents a top view of a removable wristband according to the invention mounted on a watch;

FIG. 2 represents a bottom view of a removable wristband according to the invention mounted on a watch;

FIG. 3 is an exploded bottom perspective view of a wristband according to the invention;

FIG. 4 is an exploded top perspective view of a wristband according to the invention

### DETAILED DESCRIPTION OF THE INVENTION

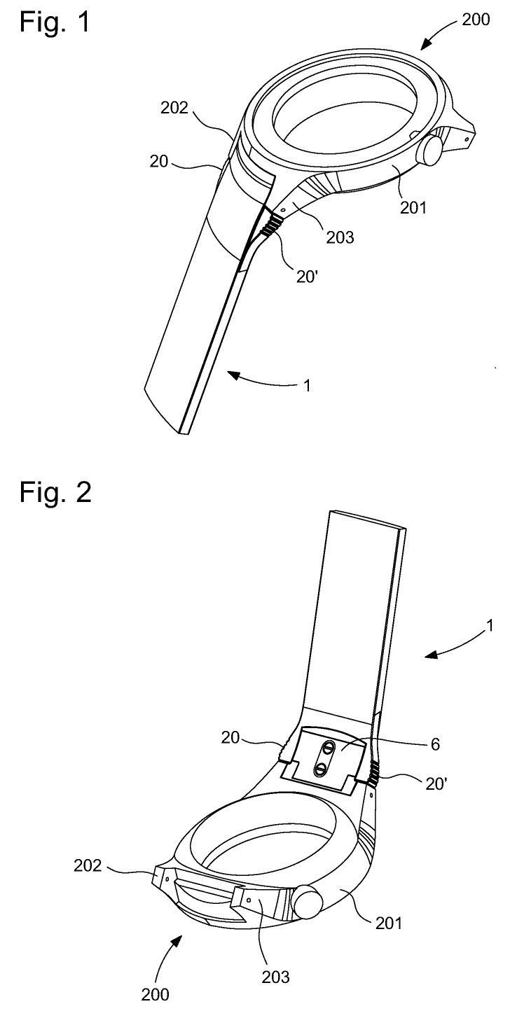

An example of a removable wristband that can be attached to a watch case will now be described as follows, referring jointly to FIGS. 1, 2, 3, and 4.

As previously mentioned, the general principle of the invention is based on the implementation of a removable wristband 1 that can be attached to a watch case 201, thereby allowing the wearer to easily change the wristband 1 of their watch 200.

As shown in FIG. 1, the wristband is composed of a fastening element 10 intended to be assembled at the end of the wristband strand 1, the fastening element 10 comprising two pins 4 and 4' aligned along the same axis, the two pins 4, 4' being movable in axial movement in a through hole 12, 12', whereby a portion of each movable pin 4, 4' is protruding to allow attachment to the lugs 202, 203 of the watch case 201 by engaging the protruding part of the pins in one of the aligned holes each of the lugs 202, 203.

This device could also be used with a watch without lugs. The holes could be machined directly into the watch case, for example.

Elastic return means, such as a coil spring 5, are provided between the pins 4, 4', the spring 5 being positioned between the pins and holding them in their extended position.

The fastening element 10 also comprises a first and a second lever 3, 3' whose rotational movement allows the pins 4, 4' to be retracted or extended. Each lever 3, 3' includes a finger 30, 30' that cooperates with each pin 4, 4', and each finger pressing against a flange 40, 40' formed on each pin to move the latter in translation as the levers 3, 3' are moved.

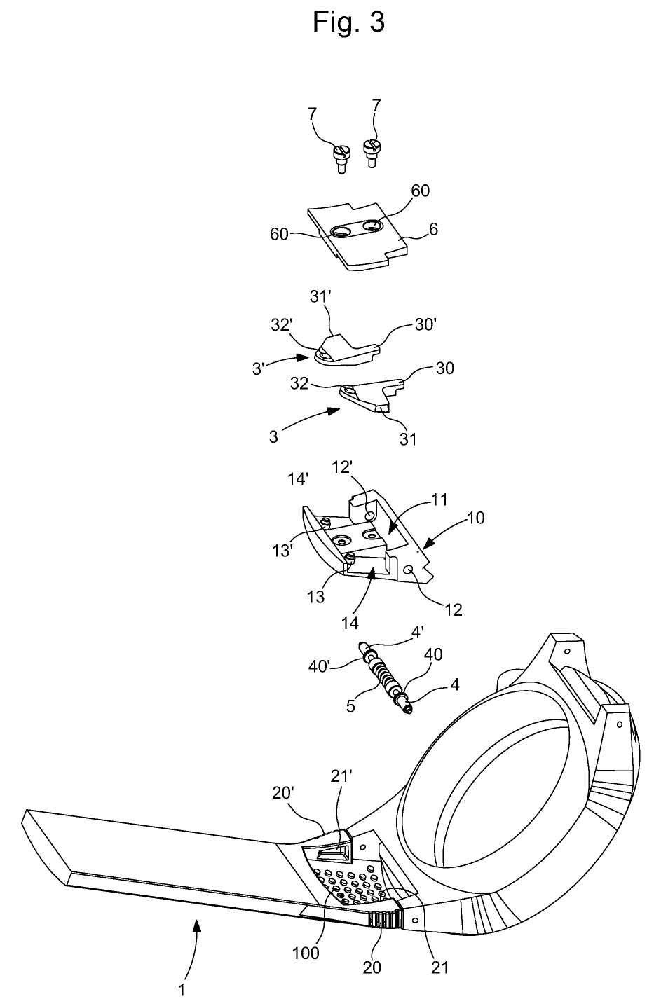

As can be seen in FIG. 3, the levers 3, 3', the pins 4, 4' and the spring 5 rest in a housing 11 of the fastening element 10. The housing 11 includes pins 13, 13' about which the levers 3, 3' are mounted via holes 32, 32' to allow the levers to rotate and the pins to move from an extended position to a retracted position by compressing the spring 5. Rotating the levers 3, 3' results in rotating the fingers 30, 30' which will drive the pins 4, 4' and bring them closer to each other against the force of the spring 5.

Each lever 3, 3' also includes a protrusion 31, 31' that is protruding through a passageway of the fastening element 10 when the pins are in the extended position. Advantageously, the protrusions each lie in a cavity 21, 21' of a push rod 20, 20' formed on the edge of the wristband strand. The fastening element 10 comprises openings 14, 14' for passing the protrusions 31, 31' into the cavities 21, 21', the openings being placed opposite the cavities.

According to the invention, the push rods 20, 20' are integral with the wristband, a push rod 20, 20' being arranged on each edge of the wristband. The push rods are preferably made of an elastically deformable material, such as rubber or silicone... The wristband can be made of a material that is identical to the push rods or a different material.

Thus, the movement of the levers 3, 3' is caused by simultaneously pressing push rods 20, 20' in a transverse direction relative to the wristband, leading to elastic deformation of the push rods, retracting the pins 4, 4' and unlocking the wristband from the frame to allow the wearer to detach the wristband from the frame.

Due to the restoring force of the spring 5, when the push rods 20, 20' are released, the system will naturally return to the extended position of the pins.

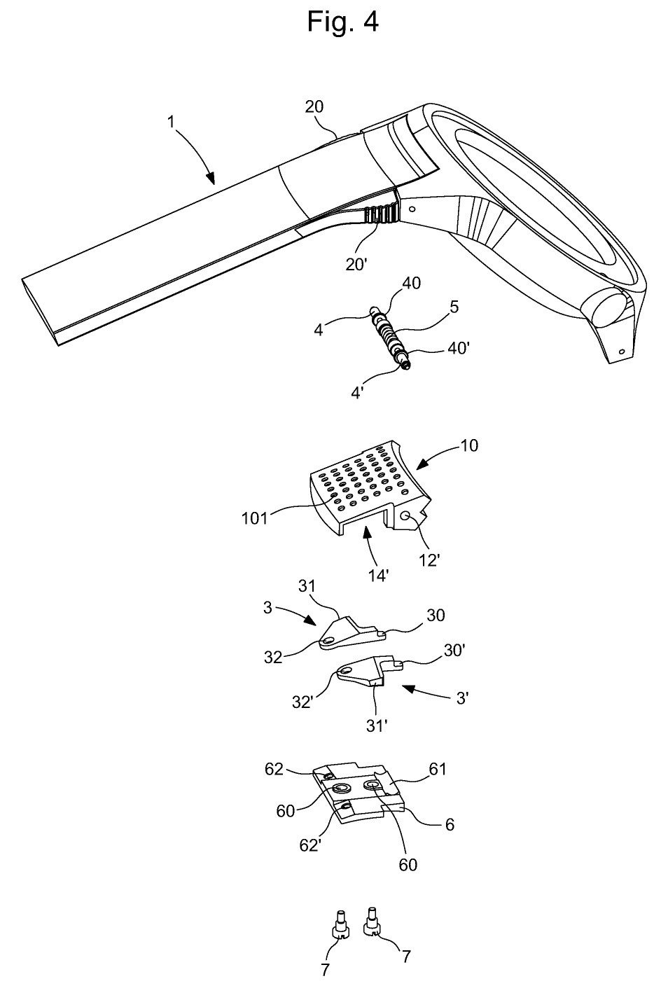

As can be seen in FIGS. 3 and 4, the wristband 1 comprises a cover 6 arranged to cover the housing 11 of the fastening element 10. The cover 6 is removably mounted to the fastening element 10 by means of screws 7 passing through the cover 6 via the hole 6a and screwing into the body of the fastening element 10.

The cover 6 has a guide channel 61 for guiding and holding the pins 4, 4' and the spring 5 after the cover 6 is assembled. The cover also includes holes 62 arranged to cooperate with the free end of the pins 13, 13' and axially hold the levers 3, 3'.

Advantageously, the fastening element 10 is formed of a single piece, and is made of a rigid material that is unlikely to deform. The fastening element 10 may, for example, be made of a metal material or metal alloy, or from a polymer material such as polyoxymethylene or any other rigid synthetic material. Such an arrangement allows a relatively compact and discreet, or even invisible, removable wristband to be obtained, once the wristband strand is assembled on the watch case.

It should also be noted that the wristband 1 and the fastening element have complementary fastening means to ensure that the two elements are securely attached to each other once assembled. As illustrated, these complementary fastening means are in the shape of a multitude of holes 101 and studs 100. Clearly, other shapes can be considered, such as squares, diamonds or even crosses.

To facilitate the operation and gripping of the push rods 20, 20', they comprise a smooth or textured surface that can also serve as a reference point for the wearer and indicate the area to be pressed to release the wristband strand.

To affix a wristband strand 1 to a watch case 201 (or frame), push rods 20, 20' are pressed simultaneously in a transverse direction relative to the wristband, leading to elastic deformation of the push rods, thereby rotating the levers 3, 3'. The 4, 4' movable pins then retract under the action of the 30, 30' fingers of the levers, and the wristband can be inserted first between the lugs 202, 203.

The fastening element 10 is then ensured to be in the same plane as the watch case so as to align the pin axis 4, 4' with the axis of the lug holes and the pressure on the push rods is released to make the pins enter the lug holes under the action of the spring 5.

Simply perform the operation in reverse to detach the wristband strand from the watch case.

Advantageously, the push rods are located on the edges of the wristband strand so that they can be handled easily, even when the watch is worn. In addition, the push rods remain very discreet, as they are integrated directly into the wristband strand.

Thanks to these different aspects of the invention, the wristband is removable, allowing it to be changed quickly and easily.

1. A removable wristband connectable to a watch case, the wristband comprising a fastening element, at least two retractable pins held in an extended position by elastic return means, two movable levers independent of each other, the movement of said levers moving the pins into a retracted position allowing the wristband to be detached from the frame, the movement of the levers being caused by simultaneously exerted pressure on push rods in a transverse direction relative to the wristband leading to elastic deformation of the push rods and unlocking the wristband from the frame to allow the wearer to detach the wristband from the frame, the push rods being integral with the wristband, a push rod being formed on each edge of the wristband.

2. The wristband according to claim 1, wherein the fastening element has a housing in which the levers, the pins and the elastic return means are resting.

3. The wristband according to claim 1, wherein the fastening element comprises two through holes arranged to receive the pins, the end of each pin being protruding.

4. The wristband according to claim 1, wherein the fastening element is sealed by a cover.

5. The wristband according to claim 1, wherein the levers are rotationally hinged around a pin in the housing.

6. The wristband according to claim 1, wherein each lever comprises a finger arranged to cooperate with a pin.

7. The wristband according to claim 1, wherein each lever comprises a protrusion arranged to rest in a cavity of a push rod.

8. The wristband according to claim 7, wherein the fastening element comprises openings for passing the protrusions from the levers to the cavities.

9. The wristband according to claim 1, wherein the wristband comprises complementary fastening means with the fastening element.

10. The wristband according to claim 1, wherein the cover comprises a passageway for guiding and maintaining the pins and the elastic return means in translation.

11. The wristband according to claim 4, wherein the cover comprises two holes arranged to cooperate with the pins so as to axially hold the levers.

12. The wristband according to claim 1, characterised in that the wristband is made of a material such as rubber or silicone.

13. The wristband according to claim 1, wherein the fastening element is made of a rigid synthetic material such as polyoxymethylene.
